(19) United States
(12) Patent Application Publication
(10) Pub. No.: US 2020/0025324 A1
(43) Pub. Date: Jan. 23, 2020

(54) PROCESS FOR PRODUCING AEROGEL COMPOSITE, AEROGEL COMPOSITE, AND HEAT-INSULATED OBJECT

(71) Applicant: HITACHI CHEMICAL COMPANY, LTD., Tokyo (JP)

(72) Inventors: Hiroyuki IZUMI, Chiyoda-ku, Tokyo (JP); Tatsuya MAKINO, Chiyoda-ku, Tokyo (JP); Tomohiko KOTAKE, Chiyoda-ku, Tokyo (JP)

(21) Appl. No.: 16/337,950

(22) PCT Filed: Sep. 30, 2016
(86) PCT No.: PCT/JP2016/079165

§ 371 Date: Mar. 29, 2019

(51) Int. Cl. F16L 59/02; C09D 5/00; C09D 183/06; B32B 5/16

(52) U.S. Cl. CPC F16L 59/029; C09D 5/00; C09D 183/06; B32B 2307/304; F16L 59/028; B32B 2307/414; B32B 2307/72; B32B 5/16

(57) ABSTRACT

The present invention relates to a process for producing an aerogel composite, comprising a step of infiltrating a coating liquid containing a coating material and a solvent in aerogel and a step of removing the solvent from the infiltrated coating liquid.

### TECHNICAL FIELD

The present invention relates to producing aerogel composite, aerogel composite, and heat-insulated object.

### BACKGROUND ART

Aerogel is known as a material having low thermal conductivity. Aerogel has a microporous structure, which allows suppressing the movement of gas including air inside, and achieving low thermal conductivity. As a heat insulating member utilizing such characteristics of the aerogel, a heat insulating sheet provided with a sheet-like aerogel has been developed (see, for example, Patent Literature 1).

### CITATION LIST

### Patent Literature

Patent Literature 1: Japanese Unexamined Patent Publication No. 2010-167685

### SUMMARY OF INVENTION

### Technical Problem

The aerogel may be referred to as an aggregate of nano-sized fine particles, and there is a problem of dust generation (dust fall) caused by fine particles detached from the surface of the aerogel at the time of use. Another problem is that the aerogel's skeleton itself easily becomes brittle and lacks sufficient durability. These problems eventually lead to a deterioration of its function as a heat insulating member. In general, since a heat insulating member needs to insulate an object for a long time, it is currently difficult for the aerogel to perform sufficiently as a heat insulating member for a long time.

In Patent Literature 1, in order to mainly address the problem of dust generation, an aerogel sheet is sandwiched between resin-coated glass fiber cloths and the like, and is used as a laminate for heat insulation.

However, with the technology of Patent Literature 1, even if dust generation from the aerogel surface to the outside can be suppressed, it does not necessarily mean that the dust generation itself could be suppressed. In addition, since the brittleness of the aerogel sheet itself is not improved, the aerogel's skeleton itself may break due to external impact. Thus, in the conventional technique, toughening of the aerogel is desired since the excellent low thermal conductivity of the aerogel can be easily lost.

The present invention has been made in light of the situation described above, and an object thereof is to provide a process for producing an aerogel composite having excellent toughness, an aerogel composite and a heat-insulated object.

### Solution to Problem

The present invention provides a method for producing an aerogel composite, comprising a step of infiltrating a coating liquid containing a coating material and a solvent in aerogel, and a step of removing the solvent from the infiltrated coating liquid. The aerogel composite obtained by such a method has excellent toughness.

In the present invention, the viscosity at 25° C. of the coating liquid may be 35 mPa·s or less. This allows formation of a good coating.

In the present invention, the coating material can include a thermosetting resin. This allows formation of a good coating.

In the present invention, the aerogel may be a dried product of wet gel being a condensate of sol containing at least one selected from the group consisting of a silicon compound having a hydrolyzable functional group or a condensable functional group, and a hydrolysis product of the silicon compound having a hydrolyzable functional group. Such aerogel has thermal insulation properties and flexibility, and is also excellent in workability.

The present invention also provides an aerogel composite having aerogel and a coating covering at least a portion of the surface of aerogel particles, the aerogel particles forming a void inside the aerogel. Such an aerogel composite has excellent toughness.

In the present invention, the density of the aerogel composite can be set to 0.30 to 1.15 g/cm³. This further improves the toughness and thermal insulation properties of the aerogel composite.

In the present invention, the transmittance to light with a wavelength of 700 nm of the aerogel composite may be 15% or less. This further improves the thermal insulation properties of the aerogel composite.

The present invention further provides a heat-insulated object comprising the aerogel composite on an object to be insulated. Because it is a heat-insulated object using an aerogel composite excellent in toughness, the excellent low thermal conductivity is not easily lost.

### Advantageous Effects of Invention

According to the present invention, a process for producing an aerogel composite having excellent toughness, an aerogel composite and a heat-insulated object can be provided.

### BRIEF DESCRIPTION OF DRAWINGS

FIG. 1 is a sectional drawing schematically showing the heat-insulated object of the present embodiment.

FIG. 2 is a cross-sectional SEM photograph of the aerogel composite obtained in Example 3.

FIG. 3 is a cross-sectional SEM photograph of the aerogel obtained in Comparative Example 1.

### DESCRIPTION OF EMBODIMENTS

Hereinafter, preferred embodiments of the present disclosure will be described in detail sometimes with reference to the drawings. However, the present disclosure is not limited by the following embodiments.

### Definition

In the present specification, a numerical range represented by using “to” means a range including the numerical values described before and after “to” as the minimum value and the maximum value, respectively. In numerical ranges described in stages in the present specification, the upper limit value or the lower limit value of a numerical range of a certain stage may be replaced with the upper limit value or the lower limit value of a numerical range of a different stage. In a numerical range described in the present specification, the upper limit value or the lower limit value of the numerical range may be replaced with a value shown in Examples. “A or B” needs only to include either A or B and may include both. Materials listed in the present specification can be used each alone or in combination of two or more thereof, unless otherwise specified. In the present specification, in the case where a plurality of substances corresponding to each component are present in a composition, the content of each component in the composition means the total amount of the plurality of substances present in the composition, unless otherwise specified.

<Heat-Insulated Object>

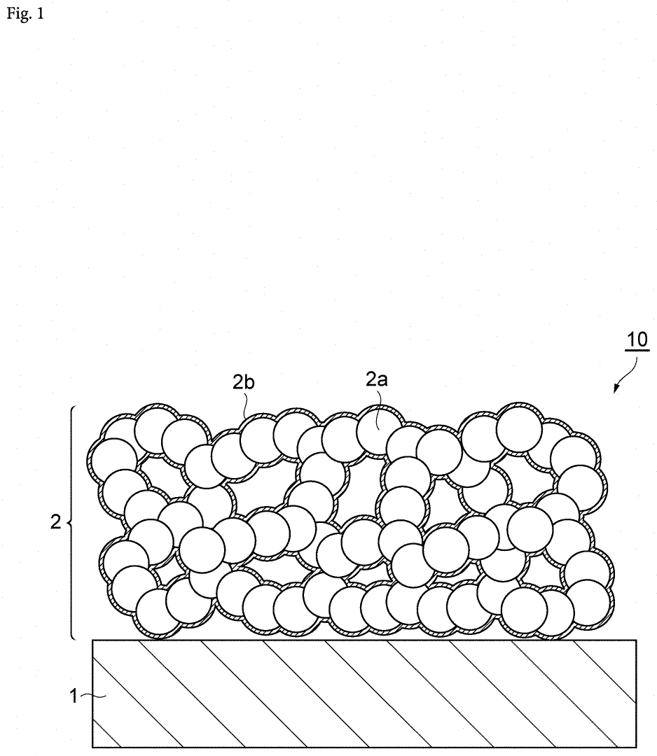

In the heat-insulated object of the present embodiment, an aerogel composite is formed on an object to be insulated. FIG. 1 is a sectional drawing schematically showing the heat-insulated object of the present embodiment. As shown in FIG. 1, in the heat-insulated object 10, the aerogel composite 2 is formed as a heat insulating layer on the object to be heat-insulated 1. The aerogel composite 2 has aerogel 2a and a coating 2b covering at least a portion of the surface of the aerogel particles, the aerogel particles forming a void inside the aerogel 2a. The aerogel 2a has a three-dimensionally fine network skeleton composed of aerogel particles, and a large number of voids exist in the skeleton. That is, in the aerogel composite 2, at least a portion of the surface of the skeleton (the aerogel 2a formed by the aerogel particles) is coated with the coating 2b, while the three-dimensional network skeleton is maintained.

The aerogel composite 2 can be provided on at least a portion (a portion or the whole) of the object to be heat-insulated 1. In the heat-insulated object 10, the object to be heat-insulated 1 and the aerogel composite 2 may be directly joined integrally, or the object to be heat-insulated 1 and the aerogel composite 2 may be joined via another layer such as a primer layer.

The heat-insulated object 10 may further include a barrier layer (not shown) on the aerogel composite 2.

(Object to be Heat-Insulated)

Examples of the material constituting the object to be heat-insulated include metals, ceramics, glass, resin, and composite materials thereof. That is, the object to be heat-insulated can include at least one selected from the group consisting of metals, ceramics, glass, and resin. As the form of the object to be heat-insulated, a block shape, a sheet shape, a powder shape, a spherical shape, a fiber shape or the like can be employed depending on the purpose of use or the material.

Examples of the metal include simple metals, alloys of metals and metals on which an oxide film is formed. Examples of the metal element include iron, copper, nickel, aluminum, zinc, titanium, chromium, cobalt, tin, gold and silver. From the viewpoint of excellent corrosion resistance to the material used in the sol production step described later, a simple substance such as titanium, gold and silver, iron and aluminum on which an oxide film is formed can be used as the metal.

Examples of the ceramics include oxides such as alumina, titania, zirconia and magnesia, nitrides such as silicon nitride and aluminum nitride, carbides such as silicon carbide and boron carbide, and mixtures thereof.

Examples of the glass include quartz glass, soda glass and borosilicate glass.

Examples of the resin include polyvinyl chloride, polyvinyl alcohol, polystyrene, polyethylene, polypropylene, polyacetal, polymethyl methacrylate, polycarbonate, polyamide and polyurethane.

By using an object to be heat-insulated having a large surface roughness or an object to be heat-insulated having a porous structure, a good anchor effect can be obtained, which allows further improvement of the adhesion to the aerogel composite. From such a viewpoint, the surface roughness Ra of the object to be heat-insulated 1 may be 100 nm or more, and may be 500 nm or more. When the object to be heat-insulated has a porous structure, from the viewpoint of further improving the heat insulation, an aspect in which the pores of the porous structure are communicating holes, and an aspect wherein the total volume of the pores is 50 to 99% of the total volume of the object to be heat-insulated, can be employed. The surface roughness Ra can be measured as follows. That is, according to JIS B0601, the arithmetic average roughness of the surface can be measured using an optical surface roughness meter (Wyko NT9100 manufactured by Veeco Metrogy Group).

(Aerogel Composite)

Definition of Aerogel

Although dry gel obtained by using a supercritical drying method for wet gel is called aerogel; dry gel obtained by drying under atmospheric pressure is called xerogel; and dry gel obtained by freeze drying is called cryogel in the narrow sense, low-density dry gel obtained regardless of these drying approaches of wet gel is referred to as “aerogel” in the present embodiment. Specifically, in the present embodiment, the “aerogel” means “gel comprised of a microporous solid in which the dispersed phase is a gas” which is aerogel in the broad sense. In general, the aerogel 2a has a network microstructure inside and has a cluster structure where aerogel particles (particles constituting the aerogel) on the order of 2 to 20 nm are bonded. Pores (voids) smaller than 100 nm reside between skeletons formed by this cluster. By this, the aerogel 2a forms a three-dimensionally fine and porous structure. The aerogel 2a according to the present embodiment is, for example, silica aerogel composed mainly of silica. Examples of the silica aerogel include so-called organic-inorganic hybridized silica aerogel in which an organic group (a methyl group, etc.) or an organic chain is introduced.

Raw Materials of Aerogel

Aerogel can be obtained using various silicon compounds as raw materials. Specifically, examples of aerogel include a dried product of wet gel being a condensate of sol (one obtained by drying wet gel produced from the sol) containing at least one selected from the group consisting of a silicon compound having a hydrolyzable functional group or a condensable functional group, and a hydrolysis product of the silicon compound having a hydrolyzable functional group. The condensate may be obtained by the condensation reaction of a hydrolysis product obtained by the hydrolysis of the silicon compound having a hydrolyzable functional group, or may be obtained by the condensation reaction of the silicon compound having a condensable functional group which is not a functional group obtained by hydrolysis. The silicon compound can have at least one of the hydrolyzable functional group and the condensable functional group and may have both of the hydrolyzable functional group and the condensable functional group.

The silicon compound can include a polysiloxane compound having a hydrolyzable functional group or a condensable functional group. That is, the sol containing the silicon compound can contain at least one selected from the group consisting of a polysiloxane compound having a hydrolyzable functional group or a condensable functional group, and a hydrolysis product of the polysiloxane compound having a hydrolyzable functional group (hereinafter, referred to as the “polysiloxane compound group” in some cases).

Examples of the hydrolyzable functional group include alkoxy groups. Examples of the condensable functional group (except for functional groups corresponding to the hydrolyzable functional group) include a hydroxy group, silanol groups, a carboxyl group and a phenolic hydroxy group. The hydroxy group may be included in a hydroxy group-containing group such as a hydroxyalkyl group. The polysiloxane compound having a hydrolyzable functional group or a condensable functional group may further have a reactivity group different from the hydrolyzable functional group and the condensable functional group (functional group that corresponds neither to the hydrolyzable functional group nor to the condensable functional group). Examples of the reactivity group include an epoxy group, a mercapto group, a glycidoxy group, a vinyl group, an acryloyl group, a methacryloyl group and an amino group. The epoxy group may be included in an epoxy group-containing group such as a glycidoxy group. The polysiloxane compound having these functional groups and reactive groups may be used alone or by mixing two or more types. Among these functional groups and reactive groups, examples of groups improving the flexibility of the aerogel include alkoxy groups, silanol groups, and hydroxyalkyl groups, and among these, alkoxy groups and hydroxyalkyl groups can further improve the compatibility of sol. Also, the number of carbon atoms of each of the alkoxy groups and the hydroxyalkyl groups can be set to 1 to 6 from the viewpoint of improvement in the reactivity of the polysiloxane compound and reduction in the thermal conductivity of the aerogel, but may be set to 2 to 4 from the viewpoint of further improving the flexibility of the aerogel.

Examples of the polysiloxane compound having a hydroxyalkyl group include one having a structure represented by the following formula (A).

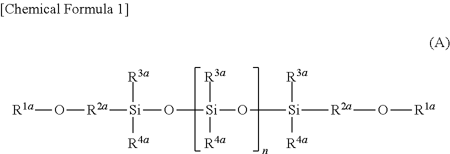

In the formula (A), R^{1a} represents a hydroxyalkyl group, R^{2a} represents an alkylene group, R^{3a} and R^{4a} each independently represent an alkyl group or an aryl group, and n represents an integer of 1 to 50. In this context, examples of the aryl group include a phenyl group and a substituted phenyl group. Also, examples of the substituent of the substituted phenyl group include alkyl groups, a vinyl group, a mercapto group, an amino group, a nitro group and a cyano group. In the formula (A), two R^{1a} may be the same as or different from each other, and likewise, two R^{2a} may be the same as or different from each other. Also, in the formula (A), two or more R^{3a} may be the same as or different from each other, and likewise, two or more R^{4a} may be the same as or different from each other.

Aerogel that has low thermal conductivity and is flexible is more easily obtained by using wet gel being a condensate of sol containing a polysiloxane compound having the structure described above. From such a viewpoint, in the formula (A), examples of R^{1a} include hydroxyalkyl groups having 1 to 6 carbon atoms, and examples of the hydroxyalkyl groups include a hydroxyethyl group and a hydroxypropyl group. Also, in the formula (A), examples of R^{2a} include alkylene groups having 1 to 6 carbon atoms, and examples of the alkylene groups include an ethylene group and a propylene group. Also, in the formula (A), examples of R^{3a} and R^{4a} each independently include alkyl groups having 1 to 6 carbon atoms and a phenyl group, and examples of the alkyl groups include a methyl group. Also, in the formula (A), n can be set to 2 to 30, but may be set to 5 to 20.

A commercially available product can be used as the polysiloxane compound having a structure represented by the above formula (A), and examples thereof include compounds such as X-22-160AS, KF-6001, KF-6002, and KF-6003 (all manufactured by Shin-Etsu Chemical Co., Ltd.), and compounds such as XF42-B0970 and Fluid OFOH 702-4% (all manufactured by Momentive Performance Materials Inc.).

Examples of the polysiloxane compound having an alkoxy group include one having a structure represented by the following formula (B).

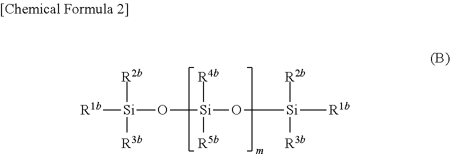

In the formula (B), R^{1b} represents an alkyl group, an alkoxy group or an aryl group, R^{2b} and R^{3b} each independently represent an alkoxy group, R^{4b} and R^{5b} each independently represent an alkyl group or an aryl group, and m represents an integer of 1 to 50. In this context, examples of the aryl group include a phenyl group and a substituted phenyl group. Also, examples of the substituent of the substituted phenyl group include alkyl groups, a vinyl group, a mercapto group, an amino group, a nitro group and a cyano group. In the formula (B), two R^{1b} may be the same as or different from each other, two R^{2b} may be the same as or different from each other, and likewise, two R^{3b} may be the same as or different from each other. Also, in the formula (B), when m is an integer of 2 or more, two or more R^{4b} may be the same as or different from each other, and likewise, two or more R^{5b} may also be the same as or different from each other.

Aerogel that has low thermal conductivity and is flexible is more easily obtained by using wet gel being a condensate of sol containing a polysiloxane compound having the structure described above or a hydrolysis product thereof. From such a viewpoint, in the formula (B), examples of R^{1b} include alkyl groups having 1 to 6 carbon atoms and alkoxy groups having 1 to 6 carbon atoms, and examples of the alkyl groups or the alkoxy groups include a methyl group, a methoxy group and an ethoxy group. Also, in the formula (B), examples of R^{2b} and R^{3b} each independently include alkoxy groups having 1 to 6 carbon atoms, and examples of the alkoxy groups include a methoxy group and an ethoxy group. Also, in the formula (B), examples of R^{4b} and R^{5b} each independently include alkyl groups having 1 to 6 carbon atoms and a phenyl group, and examples of the alkyl groups include a methyl group. Also, in the formula (B), m can be set to 2 to 30, but may be set to 5 to 20.

The polysiloxane compound having a structure represented by the above formula (B) can be obtained by appropriately referring to manufacturing methods reported in, for example, Japanese Unexamined Patent Publication No. 2000-26609 and Japanese Unexamined Patent Publication No. 2012-233110.

Since an alkoxy group hydrolyzes, there is a possibility that a polysiloxane compound having an alkoxy group exists as a hydrolysis product in sol, and the polysiloxane compound having an alkoxy group and a hydrolysis product thereof may coexist. Also, in the polysiloxane compound having an alkoxy group, all alkoxy groups in the molecule may be hydrolyzed or may be partially hydrolyzed.

These polysiloxane compounds having a hydrolyzable functional group or a condensable functional group, and hydrolysis products of the polysiloxane compounds having a hydrolyzable functional group may be used alone or by mixing two or more types.

The silicon compound may include a silicon compound other than the polysiloxane compound. Specifically, the sol of the present embodiment can contain at least one selected from the group consisting of a silicon compound (except for the polysiloxane compound) having a hydrolyzable functional group or a condensable functional group, and a hydrolysis product of the silicon compound having a hydrolyzable functional group (hereinafter, referred to as the “silicon compound group” in some cases). The number of silicon atoms in the molecule of the silicon compound can be set to 1 or 2.

Examples of the silicon compound having a hydrolyzable functional group include, but are not particularly limited to, alkyl silicon alkoxides. Among the alkyl silicon alkoxides, one having 3 or less hydrolyzable functional groups can further improve water resistance. Examples of such alkyl silicon alkoxides include monoalkyltrialkoxysilanes, monoalkyldialkoxysilanes, dialkyldialkoxysilanes, monoalkylmonoalkoxysilanes, dialkylmonoalkoxysilanes, and trialkylmonoalkoxysilanes and specifically include methyltrimethoxysilane, methyldimethoxysilane, dimethyldimethoxysilane, and ethyltrimethoxysilane.

Examples of the silicon compound having a condensable functional group include, but are not particularly limited to, silanetetraol, methylsilanetriol, dimethylsilanediol, phenylsilanetriol, phenylmethylsilanediol, diphenylsilanediol, n-propylsilanetriol, hexylsilanetriol, octylsilanetriol, decylsilanetriol and trifluoropropylsilanetriol.

The silicon compound having a hydrolyzable functional group or a condensable functional group may further have the reactive group mentioned above, which is different from the hydrolyzable functional group and the condensable functional group.

Vinyltrimethoxysilane, 3-glycidoxypropyltrimethoxysilane, 3-glycidoxypropylmethyldimethoxysilane, 3-methacryloxypropyltrimethoxysilane, 3-methacryloxypropylmethyldimethoxysilane, 3-acryloxypropyltrimethoxysilane, 3-mercaptopropyltrimethoxysilane, 3-mercaptopropylmethyldimethoxysilane, N-phenyl-3-aminopropyltrimethoxysilane, N-2-(aminoethyl)-3-aminopropylmethyldimethoxysilane or the like can also be used as the silicon compound having three or less hydrolyzable functional groups and having a reactivity group.

Also, vinylsilanetriol, 3-glycidoxypropylsilanetriol, 3-glycidoxypropylmethylsilanediol, 3-methacryloxypropylsilanetriol, 3-methacryloxypropylmethylsilanediol, 3-acryloxypropylsilanetriol, 3-mercaptopropylsilanetriol, 3-mercaptopropylmethylsilanediol, N-phenyl-3-aminopropylsilanetriol, N-2-(aminoethyl)-3-aminopropylmethylsilanediol or the like can also be used as the silicon compound having a condensable functional group and having a reactivity group.

Furthermore, bistrimethoxysilylmethane, bistrimethoxysilylethane, bistrimethoxysilylhexane ethyltrimethoxysilane, vinyltrimethoxysilane or the like, which is a silicon compound having 3 or less hydrolyzable functional groups at the molecular end, can also be used.

These silicon compounds having a hydrolyzable functional group or a condensable functional group, and hydrolysis products of the silicon compounds having a hydrolyzable functional group may be used alone or by mixing two or more types.

The sum of the contents of the polysiloxane compound group and the silicon compound group can be set to 5 parts by mass or more and may be 10 parts by mass or more, with respect to 100 parts by mass in total of the sol. The sum of the contents can be set to 50 parts by mass or less and may be 30 parts by mass or less, with respect to 100 parts by mass in total of the sol. Specifically, the sum of the contents of the polysiloxane compound group and the silicon compound group can be set to 5 to 50 parts by mass, but may be further set to 10 to 30 parts by mass, with respect to 100 parts by mass in total of the sol. It is set to 5 parts by mass or more, whereby good reactivity is more easily obtained; and it is set to 50 parts by mass or less, whereby good compatibility is more easily obtained.

The aerogel of the present embodiment may contain silica particles. That is, the sol giving the aerogel may further contain silica particles, and the aerogel of the present embodiment may be a dried product of wet gel being a condensate of sol containing silica particles.

The silica particles can be used without particular limitation, and examples thereof include amorphous silica particles. Examples of amorphous silica particles include fused silica particles, fumed silica particles and colloidal silica particles. Among these, colloidal silica particles have a high monodispersibility and easily suppress aggregation in sol.

The shape of the silica particles is not particularly limited, and examples thereof include a spherical shape, a cocoon shape, and an association type. Among these, by using spherical particles as the silica particles, aggregation in the sol is more easily suppressed. The average primary particle diameter of the silica particles can be set to 1 nm or more, may be 5 nm or more, and may be 10 nm or more, since it becomes easy to impart appropriate strength to the aerogel and aerogel having excellent shrinkage resistance during drying is more easily obtained. On the other hand, since solid heat conduction of the silica particles is more easily suppressed and aerogel having excellent heat insulation properties is more easily obtained, the average primary particle diameter of the silica particles can be set to 500 nm or less, may be 300 nm or less, and may be 250 nm or less. That is, the average primary particle diameter of the silica particles can be set to 1 to 500 nm, may be 5 to 300 nm, and may be 10 to 250 nm. The average primary particle diameter of the silica particles can be measured by observation using a scanning electron microscope (hereinafter, abbreviated to “SEM”).

Since it becomes easy to impart appropriate strength to the aerogel and aerogel having excellent shrinkage resistance during drying is more easily obtained, the content of the silica particles contained in the sol can be set to 1 part by mass or more, and may be 4 parts by mass or more, with respect to 100 parts by mass in total of the sol. Since solid heat conduction of the silica particles is more easily suppressed and aerogel having excellent heat insulation properties is more easily obtained, the content of the silica particles contained in the sol can be set to 20 parts by mass or less, may be 15 parts by mass or less, may be 12 parts by mass or less, may be 10 parts by mass or less, and may be 8 parts by mass or less. That is, the content of the silica particles can be set to 1 to 20 parts by mass, may be 4 to 15 parts by mass, may be 4 to 12 parts by mass, may be 4 to 10 parts by mass, and may be 4 to 8 parts by mass, with respect to 100 parts by mass in total of the sol.

Structure of Aerogel

The aerogel of the present embodiment can contain polysiloxane having a principal chain including a siloxane bond (Si—O—Si). The aerogel can have the following M unit, D unit, T unit or Q unit as a structural unit.

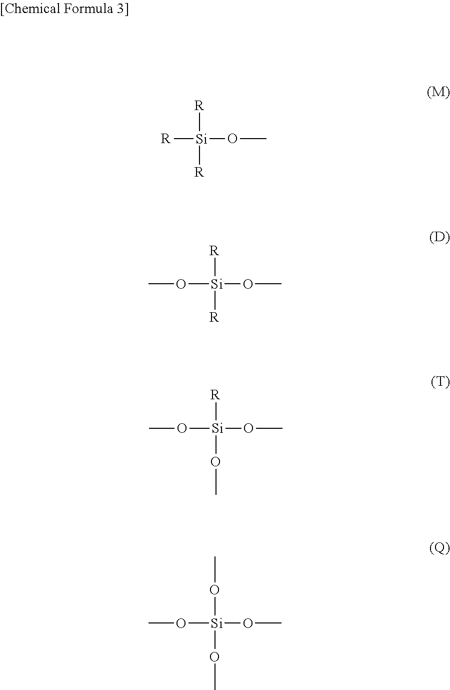

In the above formulas, R represents an atom (a hydrogen atom, etc.) or an atomic group (an alkyl group, etc.) bonded to the silicon atom. The M unit is a unit consisting of a monovalent group in which the silicon atom is bonded to one oxygen atom. The D unit is a unit consisting of a divalent group in which the silicon atom is bonded to two oxygen atoms. The T unit is a unit consisting of a trivalent group in which the silicon atom is bonded to three oxygen atoms. The Q unit is a unit consisting of a tetravalent group in which the silicon atom is bonded to four oxygen atoms. Information on the contents of these units can be obtained by Si-NMR.

Examples of the aerogel of the present embodiment include one having structures given below or the like. The aerogel has these structures and thereby easily exerts excellent thermal conductivity and compressive modulus of elasticity. In the present embodiment, the aerogel may have any of the structures given below.

The aerogel of the present embodiment can have a structure represented by the following formula (1). The aerogel of the present embodiment can have a structure represented by the following formula (1a) as a structure including the structure represented by the formula (1). The structures represented by the formula (1) and the formula (1a) can be introduced into the skeleton of the aerogel by using the polysiloxane compound having a structure represented by the above formula (A).

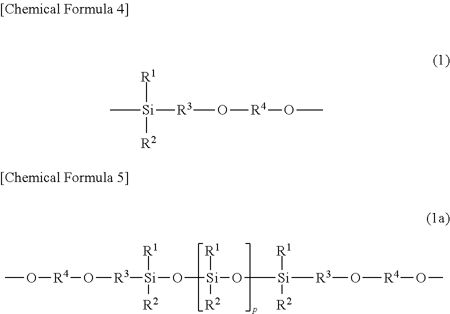

In the formula (1) and the formula (1a), R¹ and R² each independently represent an alkyl group or an aryl group, and R³ and R⁴ each independently represent an alkylene group. In this context, examples of the aryl group include a phenyl group and a substituted phenyl group. Examples of the substituent of the substituted phenyl group include alkyl groups, a vinyl group, a mercapto group, an amino group, a nitro group and a cyano group. p represents an integer of 1 to 50. In the formula (1a), two or more R¹ may be the same as or different from each other, and likewise, two or more R² may be the same as or different from each other. In the formula (1a), two R³ may be the same as or different from each other, and likewise, two R⁴ may be the same as or different from each other.

Aerogel that has low thermal conductivity and is flexible is prepared by introducing the structure represented by the above formula (1) or formula (1a) into the skeleton of the aerogel. From such a viewpoint, in the formula (1) and the formula (1a), examples of R¹ and R² each independently include alkyl groups having 1 to 6 carbon atoms and a phenyl group, and examples of the alkyl groups include a methyl group. Also, in the formula (1) and the formula (1a), examples of R³ and R⁴ each independently include alkylene groups having 1 to 6 carbon atoms, and examples of the alkylene groups include an ethylene group and a propylene group. In the formula (1a), p can be set to 2 to 30 and may be 5 to 20.

The aerogel of the present embodiment may be aerogel having a ladder-type structure having struts and bridges, wherein the bridges represented by the following formula (2). Heat resistance and mechanical strength can be improved by introducing such a ladder-type structure into the skeleton of the aerogel. The ladder-type structure having the bridges represented by the formula (2) can be introduced into the skeleton of the aerogel by using the polysiloxane compound having a structure represented by the above formula (B). In the present embodiment, the “ladder-type structure” is a structure having two struts and bridges connecting the struts (structure having the form of a so-called “ladder”). In this aspect, the aerogel skeleton may consist of a ladder-type structure, or the aerogel may partially have a ladder-type structure.

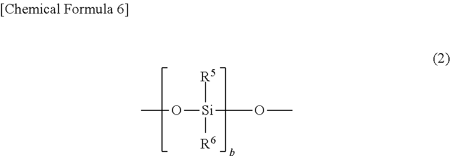

In the formula (2), R⁵ and R⁶ each independently represent an alkyl group or an aryl group, and b represents an integer of 1 to 15. In this context, examples of the aryl group include a phenyl group and a substituted phenyl group. Also, examples of the substituent of the substituted phenyl group include alkyl groups, a vinyl group, a mercapto group, an amino group, a nitro group and a cyano group. In the formula (2), when b is an integer of 2 or more, two or more R⁵ may be the same as or different from each other, and likewise, two or more R⁶ may also be the same as or different from each other.

For example, aerogel having better flexibility than that of conventional aerogel having a structure derived from ladder-type silsesquioxane (i.e., having a structure represented by the following formula (X)) is prepared by introducing the structure described above into the skeleton of the aerogel. The silsesquioxane is polysiloxane having the composition formula: (RSiO_{1.5})ₙ and can have various skeletal structures such as cage type, ladder type, and random type. As shown in the following formula (X), the structure of the bridges in the conventional aerogel having a structure derived from ladder-type silsesquioxane is —O— (has the T unit as a structural unit), whereas the structure of the bridges in the aerogel of this aspect is a structure represented by the above formula (2) (polysiloxane structure). However, the aerogel of the present embodiment may have a structure derived from silsesquioxane, in addition to the structures represented by the formulas (1) to (3).

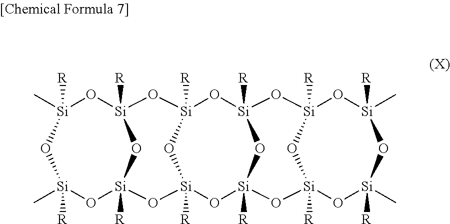

In the formula (X), R represents a hydroxy group, an alkyl group or an aryl group.

Although the structures serving as the struts and the chain length thereof, and the intervals between the structures serving as the bridges are not particularly limited, examples of the ladder-type structure include a ladder-type structure represented by the following formula (3) from the viewpoint of further improving heat resistance and mechanical strength.

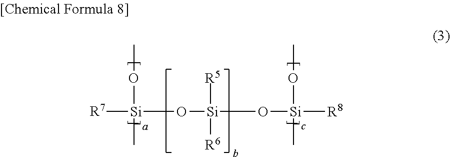

In the formula (3), R⁵, R⁶, R⁷ and R⁸ each independently represent an alkyl group or an aryl group, a and c each independently represent an integer of 1 to 3000, and b represents an integer of 1 to 50. In this context, examples of the aryl group include a phenyl group and a substituted phenyl group. Also, examples of the substituent of the substituted phenyl group include alkyl groups, a vinyl group, a mercapto group, an amino group, a nitro group and a cyano group. In the formula (3), when b is an integer of 2 or more, two or more R⁵ may be the same as or different from each other, and likewise, two or more R⁶ may also be the same as or different from each other. Also, in the formula (3), in the case where a is an integer of 2 or larger, two or more R⁷ may be the same as or different from each other, and likewise, in the case where c is an integer of 2 or larger, two or more R⁸ may be the same as or different from each other.

In the formulas (2) and (3), examples of R⁵, R⁶, R⁷ and R⁸ (however, R⁷ and R⁸ are only in the formula (3)) each independently include alkyl groups having 1 to 6 carbon atoms and a phenyl group from the viewpoint of obtaining much better flexibility, and examples of the alkyl groups include a methyl group. Also, in the formula (3), a and c can each independently be set to 6 to 2000, but may each independently further be set to 10 to 1000. Also, in the formulas (2) and (3), b can be set to 2 to 30, but may further be set to 5 to 20.

The aerogel of the present embodiment can have a structure represented by the following formula (4). The aerogel of the present embodiment can contain silica particles and have a structure represented by the following formula (4).

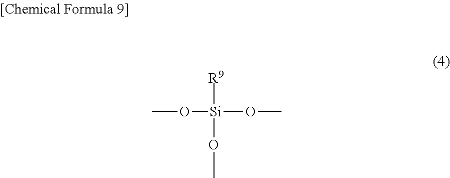

In the formula (4), R⁹ represents an alkyl group. In this context, examples of the alkyl group include alkyl groups having 1 to 6 carbon atoms, and examples of the alkyl group include a methyl group.

The aerogel of the present embodiment can have a structure represented by the following formula (5). The aerogel of the present embodiment can contain silica particles and have a structure represented by the following formula (5).

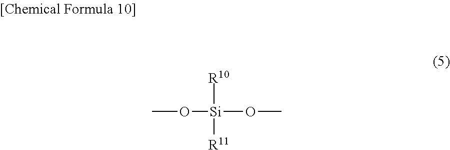

In the formula (5), R¹⁰ and R¹¹ each independently represent an alkyl group. In this context, examples of the alkyl group include alkyl groups having 1 to 6 carbon atoms, and examples of the alkyl group include a methyl group.

The aerogel of the present embodiment can have a structure represented by the following formula (6). The aerogel of the present embodiment can contain silica particles and have a structure represented by the following formula (6).

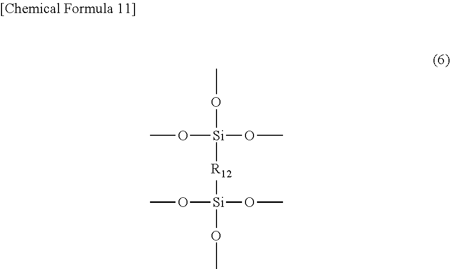

In the formula (6), R¹² represents an alkylene group. In this context, examples of the alkylene group include alkylene groups having 1 to 10 carbon atoms, and examples of the alkylene group include an ethylene group and a hexylene group.

Coating

Examples of the material forming the coating (coating material) include a thermosetting resin. Examples of the thermosetting resin include a silicone resin, a phenol resin, a urea resin, a melamine resin, an unsaturated polyester resin, an epoxy resin and a polyurethane resin. Among these, from the viewpoint of heat resistance and high strength, a silicone resin, an epoxy resin, a phenol resin or the like can be used as the coating material.

The silicone resin is not particularly limited, and examples thereof include various silicone resins such as oil silicone, elastomer silicone, resin silicone and silane silicone. Specifically, examples thereof include amino-modified siloxane, epoxy-modified siloxane, phenol-modified siloxane, methacrylate-modified siloxane, alkoxy-modified siloxane, carbinol-modified siloxane, vinyl-modified siloxane and thiol-modified siloxane. As product names, examples thereof include RSN-0409, RSN-0431, RSN-0804, RSN-0805, RSN-0806, RSN-0808, RSN-0840, and the like (manufactured by Toray Dow Corning), KF-8010, X-22-161A, KF-105, X-22-163A, X-22-169AS, KF-6001, KF-2200, X-22-164A, X-22-162C, X-22-167C, X-22-173BX and the like (manufactured by Shin-Etsu Chemical Co., Ltd.). A silicone resin in which two or more silicone resins of different type, molecular weight, functional groups etc. are mixed in a suitable ratio, can also be used.

Examples of curing agent of the silicone resin include an acid, a base and a metal catalyst. Specifically, examples thereof include acids such as hydrochloric acid, sulfuric acid, nitric acid, phosphoric acid, acetic acid and propionic acid, bases such as sodium hydroxide, potassium hydroxide, sodium carbonate, sodium hydrogencarbonate, ammonia, dimethylamine, aniline and amine-modified siloxane, and metal catalysts such as zinc naphthenate, zinc octylate, manganese naphthenate, cobalt naphthenate and cobalt octylate. These may be used alone, or two or more of them may be used in combination.

Example of the epoxy resin include polyfunctional epoxy resins such as a bisphenol A type epoxy resin, a bisphenol F type epoxy resin, a naphthalene type epoxy resin, a phenol novolac type epoxy resin, a cresol novolac type epoxy resin, a phenol aralkyl type epoxy resin, a biphenyl type epoxy resin, a triphenylmethane type epoxy resin and a dicyclopentadiene type epoxy resin. These may be used alone, or two or more of them may be used in combination.

Examples of the curing agent of the epoxy resin include a phenol resin, acid anhydrides, amines, imidazoles and phosphines. These may be used alone, or two or more of them may be used in combination.

Examples of the phenol resin include a phenol novolak resin, a cresol novolak resin, a phenol aralkyl resin, a cresol naphthol formaldehyde polycondensate and a triphenylmethane-type polyfunctional phenol resin.

Examples of the acid anhydride include methylcyclohexanetetracarboxylic dianhydride, trimellitic anhydride, pyromellitic anhydride, benzophenonetetracarboxylic dianhydride and ethylene glycol bis-anhydro trimellitate.

Examples of amines include a dicyandiamide, an alicyclic polyamine, an aliphatic polyamine and an aniline formaldehyde condensate.

Examples of the imidazoles include 2-phenylimidazole, 2-phenyl-4-methylimidazole, 1-benzyl-2-methylimidazole, 1-benzyl-2-phenylimidazole, 1-cyanoethyl-2-undecylimidazole, 1-cyano-2-phenylimidazole, 1-cyanoethyl-2-undecylimidazole trimellitate, 1-cyanoethyl-2-phenylimidazolium trimellitate, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-triazine, 2,4-diamino-6-[2′-methylimidazolyl-(1′)]-ethyl-s-triazine isocyanuric acid adduct, 2-phenylimidazole isocyanuric acid adduct, 2-phenyl-4,5-dihydroxymethylimidazole, 2-phenyl-4-methyl-5-hydroxymethylimidazole, and adducts of epoxy resins and imidazoles.

Examples of phosphines include triphenylphosphine, tetraphenylphosphonium tetraphenylborate, tetraphenylphosphonium tetra(4-methylphenyl) borate and tetraphenylphosphonium (4-fluorophenyl) borate.

As the phenol resin, those mentioned as a curing agent of epoxy resin can be used. That is, examples thereof include a phenol novolak resin, a cresol novolak resin, a phenol aralkyl resin, a cresol naphthol formaldehyde polycondensate and a triphenylmethane-type polyfunctional phenol resin.

Examples of the coating material also include polysilazane. The structure of polysilazane can be represented by the following formula (P).

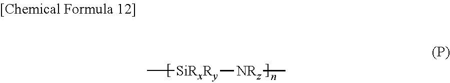

In the formula (P), Rₓ, R_{y} and R_{z} each independently represent hydrogen or an alkyl group, an aryl group, an alkenyl group, a cycloalkyl group, an alkoxy group or the like which may have a substituent. n can be set to 2 to 1000.

By reacting polysilazane with water, silicon oxide is obtained. The silicon oxide obtained using polysilazane as a raw material can contain a bond represented by Si—O, a bond represented by Si—N, a bond represented by Si—H, and a bond represented by N—H, depending on the degree of reaction between polysilazane and water. Examples of polysilazanes include organopolysilazanes such as perhydropolysilazane and methylhydropolysilazane, and silicon alkoxide-added polysilazanes obtained by reacting silicon alkoxides. From the viewpoints of heat resistance, availability, and obtaining a dense coating, perhydropolysilazane can be used as the polysilazane. The average molecular weight of the polysilazane can be set to about 100 to 50000 g/mol.

Physical Properties of Aerogel Composite

From the viewpoint of achieving both toughening and heat insulation properties, the density of the aerogel composite can be set to 0.30 g/cm³ or more, but it may be 0.50 g/cm³ or more, and may be 0.70 g/cm³ or more, and it can be set to 1.15 g/cm³ or less, but it may be 1.10 g/cm³ or less and may be 1.00 g/cm³ or less. That is, the density of the aerogel composite can be set to 0.30 to 1.15 g/cm³, but it may be 0.50 to 1.10 g/cm³, and may be 0.70 to 1.00 g/cm³. The density can be measured, for example, by a hydrometer or by measuring the sample length and weight.

From the viewpoint of achieving both toughening and heat insulation properties, the transmittance of the aerogel composite to light with a wavelength of 700 nm can be set to 15% or less, but it may be 10% or less, it may be 5% or less, and it may be 3% or less. The lower limit of the transmittance is not particularly limited, but can be set to 0. The transmittance can be measured by a spectrophotometer, a haze meter and the like.

From the viewpoint of exhibiting suitable heat insulation properties, the content of the aerogel in the aerogel composite can be set to 30 mass % or more, but it may be 40 mass % or more, and it can be set to 90 mass % or less, but it may be 80 mass % or less. That is, the content of the aerogel can be set to 30 to 90 mass %, but it may be 40 to 80 mass %. From the viewpoint of suppressing the decrease in heat insulation, the content of the coating in the aerogel composite can be set to 1 mass % or more, but it may be 5 mass % or more, and it can be set to 60 mass % or less, but it may be 50 mass % or less. That is, the content of the coating can be set to 1 to 60 mass %, but it may be 5 to 50 mass %.

The thickness of the aerogel composite may be 1 μm or more, may be 10 μm or more, and may be 30 μm or more, since good heat insulation is more easily obtained. From the viewpoint of shortening the washing and solvent replacement steps and the drying step described later, the thickness of the aerogel composite may be 1000 μm or less, may be 200 μm or less, and may be 100 μm or less. From these viewpoints, the thickness of the aerogel composite may be 1 to 1000 μm, may be 10 to 200 μm, and may be 30 to 100 μm.

(Barrier Layer)

The barrier layer is formed for the purpose of improving the brittleness of the aerogel composite, improving the oil resistance, and the like. Examples of the material forming the barrier layer (barrier layer-forming material) include a reaction product of polysilazane and water and a siloxane-based compound.

The polysilazanes described above can be used as the polysilazane.

The siloxane-based compound is a compound having a siloxane bond (Si—O—Si bond). Examples of siloxane-based compounds include polymers or oligomers having a siloxane bond (Si—O—Si bond). Specific examples of siloxane-based compounds include silicone (silicon resin), a condensate of organic silicon compounds having hydrolyzable functional groups, and a silicone-modified polymer. Examples of the organic silicon compound having a hydrolyzable functional group include methyltrimethoxysilane, dimethyldimethoxysilane and trimethylmethoxysilane. From the viewpoint of adhesion to the aerogel layer, heat resistance, and the like, the siloxane-based compound may be, for example, silicone or a condensate of methyltrimethoxysilane.

The barrier layer may further include, for example, a filler. Examples of the material constituting the filler include metals and ceramic. Examples of the metal include simple metals; alloys of metals; and metals on which an oxide film is formed. Examples of the metal include iron, copper, nickel, aluminum, zinc, titanium, chromium, cobalt, tin, gold and silver. Examples of the ceramic include oxides such as alumina, titania, zirconia and magnesia; nitrides such as silicon nitride and aluminum nitride; carbides such as silicon carbide and boron carbide; and mixtures thereof. The material constituting the filler may be, for example, fused silica, fumed silica, colloidal silica, hollow silica, glass, and scaly silica. Examples of the glass include quartz glass, soda glass and borosilicate glass.

From the viewpoint of more easily obtaining a dense barrier layer, the content of the barrier layer-forming material in the barrier layer may be, for example, 20 volume % or more, may be 30 volume % or more, and may be 40 volume % or more, to the total volume of the barrier layer. From the viewpoint of improving the workability for forming the barrier layer, the content of the barrier layer-forming material may be, for example, 80 volume % or less, may be 70 volume % or less, and may be 60 volume % or less, to the total volume of the barrier layer. When the barrier layer contains a filler, from the viewpoint of suppressing the permeation of the barrier layer composition into the aerogel composite and improving the heat resistance, the content of the filler in the barrier layer may be, for example, 0.1 volume % or more, may be 1 volume % or more, and may be 5 volume % or more, to the total volume of the barrier layer.

From the viewpoint of improving brittleness, improving oil resistance, and the like, the thickness of the barrier layer may be, for example, 1 μm or more, may be 5 μm or more, and may be 10 μm or more. From the viewpoint of improving the handleability after the barrier layer is formed, the thickness of the barrier layer may be, for example, 1000 μm or less, may be 200 μm or less, and may be 100 μm or less. From the viewpoint of obtaining better heat insulation and oil resistance, the total thickness of the aerogel composite and the barrier layer may be, for example, 2 μm or more, may be 15 μm or more, and may be 40 μm or more. From the viewpoint of shortening the production process time, improving the handleability, and the like, the total thickness of the aerogel composite and the barrier layer may be, for example, 2000 μm or less, may be 400 μm or less, and may be 200 μm or less.

<Method for Producing Heat-Insulated Object>

Next the method for producing the heat-insulated object will be described. The heat-insulated object can be produced by a method comprising, for example, a step of forming the aerogel on the object to be heat-insulated (A: aerogel forming step); and a step of infiltrating a coating liquid into the aerogel and then removing a solvent (B: coating step). When the heat-insulated object comprises a barrier layer, a step of forming the barrier layer on the aerogel composite obtained by these steps (C: barrier layer forming step) can be further performed.

A: Aerogel Forming Step

The aerogel forming step can mainly comprise: a sol production step of producing a sol for forming the aerogel; a sol coating forming step of coating the obtained sol on the object to be heat-insulated to form a sol coating; a wet gel production step of producing wet gel from the sol coating; a step of washing the wet gel (and replacing the solvent as necessary); and a drying step of drying the washed wet gel. The “sol” means a state before gelling reaction occurs, and in the present embodiment, a state where the silicon compound (and, if necessary, also the silica particles) are dissolved or dispersed in a solvent. Also, the “wet gel” means gel solid matter in a wet state lacking fluidity, even though including a liquid medium.

(Sol Production Step)

The sol production step is, for example, a step of mixing the silicon compound (and, if necessary, also the silica particles) with a solvent, and performing a hydrolysis reaction to produce sol. In this step, an acid catalyst can be further added in order to accelerate the hydrolysis reaction. Also, as shown in Japanese Patent No. 5250900, a surfactant, a thermally hydrolyzable compound and the like can also be added. Furthermore, components such as carbon graphite, an aluminum compound, a magnesium compound, a silver compound, and a titanium compound may be added for the purpose of suppressing heat radiation and the like.

For example, water or a mixed solution of water and an alcohol can be used as the solvent. Examples of the alcohol include methanol, ethanol, n-propanol, 2-propanol, n-butanol, 2-butanol and t-butanol. Among these, examples of an alcohol having low surface tension and a low boiling point, for reducing interfacial tension with gel walls, include methanol, ethanol, and 2-propanol. These may be used alone or by mixing two or more types.

In the case of using, for example, an alcohol as the solvent, the amount of the alcohol may be, for example, 4 to 8 mol, may be 4 to 6.5 mol and may be 4.5 to 6 mol, with respect to 1 mol in total of the silicon compound. The amount of the alcohol is set to 4 mol or more, whereby good compatibility is more easily obtained; and it is set to 8 mol or less, whereby the shrinkage of gel is more easily suppressed.

Examples of the acid catalyst include: inorganic acids such as hydrofluoric acid, hydrochloric acid, nitric acid, sulfuric acid, sulfurous acid, phosphoric acid, phosphorous acid, hypophosphorous acid, bromic acid, chloric acid, chlorous acid, and hypochlorous acid; acidic phosphates such as acidic aluminum phosphate, acidic magnesium phosphate, and acidic zinc phosphate; and organic carboxylic acids such as acetic acid, formic acid, propionic acid, oxalic acid, malonic acid, succinic acid, citric acid, malic acid, adipic acid, and azelaic acid. Among these, examples of an acid catalyst further improving the water resistance of the resulting aerogel include organic carboxylic acids. Examples of the organic carboxylic acids include acetic acid, but formic acid, propionic acid, oxalic acid, or malonic acid or the like is also acceptable. These may be used alone or by mixing two or more types.

The sol can be obtained in a shorter time by using the acid catalyst and thereby accelerating the hydrolysis reaction of the silicon compound.

The amount of the acid catalyst added can be set to, for example, 0.001 to 0.1 parts by mass with respect to 100 parts by mass in total of the silicon compound group.

A nonionic surfactant, an ionic surfactant or the like can be used as the surfactant. These may be used alone or by mixing two or more types.

For example, compound including a hydrophilic moiety such as polyoxyethylene and a hydrophobic moiety consisting mainly of an alkyl group, or compound including a hydrophilic moiety such as polyoxypropylene can be used as the nonionic surfactant. Examples of the compound including a hydrophilic moiety such as polyoxyethylene and a hydrophobic moiety consisting mainly of an alkyl group include polyoxyethylene nonyl phenyl ether, polyoxyethylene octyl phenyl ether, and polyoxyethylene alkyl ethers. Examples of the compound including a hydrophilic moiety such as polyoxypropylene include polyoxypropylene alkyl ethers and block copolymers of polyoxyethylene and polyoxypropylene.

Examples of the ionic surfactant include a cationic surfactant, an anionic surfactant, and an amphoteric surfactant. Examples of the cationic surfactant include cetyl trimethyl ammonium bromide and cetyl trimethyl ammonium chloride. Examples of the anionic surfactant include sodium dodecylsulfonate. Also, examples of the amphoteric surfactant include amino acid-based surfactants and betaine-based surfactants and amine oxide-based surfactants. Examples of the amino acid-based surfactants include acylglutamic acid. Examples of the betaine-based surfactants include lauryl dimethylaminoacetic acid betaine and stearyl dimethylaminoacetic acid betaine. Examples of the amine oxide-based surfactants include lauryl dimethylamine oxide.

These surfactants, in the wet gel production step, are thought to have the effect of decreasing the difference in chemical affinity between the solvent in the reaction system and a growing siloxane polymer, and suppressing phase separation.

The amount of the surfactant added may be, for example, 1 to 100 parts by mass and may be 5 to 60 parts by mass, with respect to 100 parts by mass in total of the silicon compound, though also depending on the type of the surfactant, or the types and amounts of the silicon compound.

The thermally hydrolyzable compound is thought to generate a base catalyst by thermal hydrolysis so that the reaction solution is rendered basic to accelerate the sol-gel reaction in the wet gel production step. Accordingly, this thermally hydrolyzable compound is not particularly limited as long as being a compound that can render the reaction solution basic after hydrolysis, and examples thereof can include: urea; acid amides such as formamide, N-methylformamide, N,N-dimethylformamide, acetamide, N-methylacetamide, and N,N-dimethylacetamide; and cyclic nitrogen compounds such as hexamethylenetetramine. Among these, particularly, urea is more likely to produce the accelerating effect described above.

The amount of the thermally hydrolyzable compound added is not particularly limited as long as being an amount that can sufficiently accelerate the sol-gel reaction in the wet gel production step. For example, in the case of using urea as the thermally hydrolyzable compound, the amount thereof added may be, for example, 1 to 200 parts by mass and may be 2 to 150 parts by mass, with respect to 100 parts by mass in total of the silicon compound. The amount added is set to 1 part by mass or more, whereby good reactivity is more easily obtained; and it is set to 200 parts by mass or less, whereby the deposition of crystals and decrease in gel density are more easily suppressed.

The hydrolysis in the sol production step may be performed, for example, for 10 minutes to 24 hours in a temperature environment of 20 to 60° C., and may be performed for 5 minutes to 8 hours in a temperature environment of 50 to 60° C., though also depending on the types and amounts of the silicon compound, the silica particle, the acid catalyst, the surfactant, etc. in the mixed solution. By this, the hydrolyzable functional groups in the silicon compound are sufficiently hydrolyzed so that a hydrolysis product of the silicon compound can be more reliably obtained.

However, in the case of adding the thermally hydrolyzable compound into the solvent, the temperature environment in the sol production step may be adjusted to a temperature that suppresses the hydrolysis of the thermally hydrolyzable compound and suppresses the gelling of the sol. The temperature at this time may be any temperature as long as being a temperature that can suppress the hydrolysis of the thermally hydrolyzable compound. For example, in the case of using urea as the thermally hydrolyzable compound, the temperature environment in the sol production step may be 0 to 40° C. and may be 10 to 30° C.

(Sol Coating Forming Step)

The sol coating forming step is a step of coating a sol coating solution containing the above sol to an object to be heat-insulated to form a sol coating. The sol coating solution may be in an aspect consisting of the sol. In addition, the sol coating solution may be one obtained by gelling (semi-gelling) the sol to such a degree as to have fluidity. The sol coating solution may contain, for example, a base catalyst to promote gelling.

Examples of the base catalyst include: alkali metal hydroxides such as lithium hydroxide, sodium hydroxide, potassium hydroxide, and cesium hydroxide; ammonium compounds such as ammonium hydroxide, ammonium fluoride, ammonium chloride, and ammonium bromide; basic phosphoric acid sodium salts such as sodium metaphosphate, sodium pyrophosphate, and sodium polyphosphate; aliphatic amines such as allylamine, diallylamine, triallylamine, isopropylamine, diisopropylamine, ethylamine, diethylamine, triethylamine, 2-ethylhexylamine, 3-ethoxypropylamine, diisobutylamine, 3-(diethylamino)propylamine, di-2-ethylhexylamine, 3-(dibutylamino)propylamine, tetramethylethylenediamine, t-butylamine, sec-butylamine, propylamine, 3-(methylamino)propylamine, 3-(dimethylamino)propylamine, 3-methoxyamine, dimethylethanolamine, methyldiethanolamine, diethanolamine, and triethanolamine; and nitrogen-containing heterocyclic compounds such as morpholine, N-methylmorpholine, 2-methylmorpholine, piperazine and derivatives thereof, piperidine and derivatives thereof, and imidazole and derivatives thereof. Among these, ammonium hydroxide (ammonia water) is excellent in terms of not impairing water resistance because of being highly volatile and being less likely to remain in the aerogel after drying, and furthermore, in terms of economic efficiency. The base catalysts described above may be used alone or by mixing two or more types.

The dehydration condensation reaction and/or dealcoholization condensation reaction of the silicon compound and the silica particles in the sol can be accelerated, and the gelling of the sol can be performed in a shorter time, by using the base catalyst. By this, wet gel having higher strength (rigidity) can also be obtained. Since, particularly, ammonia is highly volatile and is less likely to remain in the aerogel, aerogel having much better water resistance can be obtained by using ammonia as the base catalyst.

The amount of the base catalyst added may be, for example, 0.5 to 5 parts by mass and may be 1 to 4 parts by mass, with respect to 100 parts by mass in total of the silicon compound. The amount added is set to 0.5 parts by mass or more, whereby the gelling can be performed in a shorter time; and it is set to 5 parts by mass or less, whereby reduction in water resistance can be further suppressed.

When semi-gelling the sol, the gelling may be performed in a closed vessel such that the solvent and the base catalyst do not volatilize. In this case, the gelling temperature may be 30 to 90° C., and may be 40 to 80° C. The gelling temperature is set to 30° C. or higher, whereby the gelling can be performed in a shorter time. Also, the gelling temperature is set to 90° C. or lower, whereby the gelling can be performed with volume shrinkage suppressed because the volatilization of the solvent (particularly, an alcohol) is easily suppressed.

The gelling time when semi-gelling the sol varies depending on the gelling temperature, but when silica particles are contained in the sol, the gelling time can be shortened compared to the sol applied to conventional aerogel. The reason is presumed to be that the reactive group or silanol group possessed by the silicon compound in the sol forms a hydrogen bond or a chemical bond with the silanol group of the silica particles. The gelling time may be, for example, 10 to 360 min, and may be 20 to 180 min. When the gelling time is 10 min or more, the viscosity of the sol can be appropriately improved, the coating property to the object to be heat-insulated can be improved, and when it is 360 min or less, the complete gelling of the sol can be more easily suppressed, and good adhesion to the object to be heat-insulated can be more easily obtained.

The method for coating the sol coating solution to the object to be heat-insulated is not particularly limited, but examples thereof include dip coating, spray coating, spin coating and roll coating.

(Wet Gel Production Step)

The wet gel production step is, for example, a step of producing wet gel from the sol coating. In the wet gel production step, for example, the sol coating is gelled by heating the sol coating, and then the resulting gel is aged as necessary to form wet gel. The wet gel production step may be performed in a closed vessel such that the solvent and the base catalyst do not volatilize. When aging the gel in the wet gel production step, the bond of the components constituting the wet gel is strengthened, and as a result, wet gel having high strength (rigidity) sufficient for suppressing shrinkage at the time of drying can be easily obtained. The heating temperature and aging temperature in the wet gel production step may be, for example, 30 to 90° C., and may be 40 to 80° C. The heating temperature or the aging temperature is set to 30° C. or higher, whereby wet gel having higher strength (rigidity) can be obtained; and the heating temperature or the aging temperature is set to 90° C. or lower, whereby the gelling can be performed with volume shrinkage suppressed because the volatilization of the solvent (particularly, an alcohol) is easily suppressed.

(Washing and Solvent Replacement Step)

The washing and solvent replacement step is a step having a step of washing the wet gel obtained by the wet gel production step (washing step), and a step of replacing the washes in the wet gel with a solvent suitable for dry conditions (drying step mentioned later) (solvent replacement step). Although the washing and solvent replacement step may be carried out in a mode of performing only the solvent replacement step without performing the step of washing the wet gel, the wet gel may be washed from the viewpoint of reducing impurities such as unreacted products and by-products in the wet gel, and permitting manufacture of aerogel having higher purity. When silica particles are contained in the gel, a solvent replacement step is not necessarily required, as mentioned later.

In the washing step, the wet gel obtained in the wet gel production step is washed. The washing can be repetitively performed by using, for example, water or an organic solvent. In this respect, washing efficiency can be improved by warming.

Various organic solvents such as methanol, ethanol, 1-propanol, 2-propanol, 1-butanol, acetone, methyl ethyl ketone, 1,2-dimethoxyethane, acetonitrile, hexane, toluene, diethyl ether, chloroform, ethyl acetate, tetrahydrofuran, methylene chloride, N,N-dimethylformamide, dimethyl sulfoxide, acetic acid, and formic acid can be used as the organic solvent. The organic solvents described above may be used alone or by mixing two or more types.

In the solvent replacement step mentioned later, a solvent having low surface tension can be used for suppressing the shrinkage of the gel caused by drying. However, the solvent having low surface tension generally has very low mutual solubility in water. Therefore, in the case of using the solvent having low surface tension in the solvent replacement step, examples of the organic solvent used in the washing step include a hydrophilic organic solvent having high mutual solubility in both of water and the solvent having low surface tension. The hydrophilic organic solvent used in the washing step can play a role in preliminary replacement for the solvent replacement step. Among the organic solvents described above, examples of the hydrophilic organic solvent include methanol, ethanol, 2-propanol, acetone, and methyl ethyl ketone. Methanol, ethanol, methyl ethyl ketone or the like is excellent in terms of economic efficiency.

The amount of water or the organic solvent used in the washing step can be set to an amount that can sufficiently replace the solvent in the wet gel and permit washing. The amount can be set to, for example, an amount of 3 to 10 times the volume of the wet gel. The washing can be repeated, for example, until the water content in the wet gel after the washing becomes 10% by mass or less with respect to the silica mass.

The temperature environment in the washing step can be set to a temperature equal to or lower than the boiling point of the solvent used in washing. In the case of using, for example, methanol, the temperature may be the order of 30 to 60° C.

In the solvent replacement step, the solvent of the washed wet gel is replaced with a predetermined solvent for replacement in order to suppress shrinkage in the drying step mentioned later. In this respect, replacement efficiency can be improved by warming. Specific examples of the solvent for replacement include a solvent having low surface tension mentioned later, in the case of drying under atmospheric pressure at a temperature lower than the critical point of the solvent used in drying in the drying step. On the other hand, in the case of performing supercritical drying, examples of the solvent for replacement include ethanol, methanol, 2-propanol, dichlorodifluoromethane, carbon dioxide, and a mixed solvent of two or more of these.

Examples of the solvent having low surface tension include solvents whose surface tension at 20° C. is 30 mN/m or lower. The surface tension may be 25 mN/m or lower and 20 mN/m or lower. Examples of the solvent having low surface tension include: aliphatic hydrocarbons such as pentane (15.5), hexane (18.4), heptane (20.2), octane (21.7), 2-methylpentane (17.4), 3-methylpentane (18.1), 2-methylhexane (19.3), cyclopentane (22.6), cyclohexane (25.2), and 1-pentene (16.0); aromatic hydrocarbons such as benzene (28.9), toluene (28.5), m-xylene (28.7), and p-xylene (28.3); halogenated hydrocarbons such as dichloromethane (27.9), chloroform (27.2), carbon tetrachloride (26.9), 1-chloropropane (21.8), and 2-chloropropane (18.1); ethers such as ethyl ether (17.1), propyl ether (20.5), isopropyl ether (17.7), butyl ethyl ether (20.8), and 1,2-dimethoxyethane (24.6); ketones such as acetone (23.3), methyl ethyl ketone (24.6), methyl propyl ketone (25.1), and diethyl ketone (25.3); and esters such as methyl acetate (24.8), ethyl acetate (23.8), propyl acetate (24.3), isopropyl acetate (21.2), isobutyl acetate (23.7), and ethyl butyrate (24.6) (the surface tension at 20° C. is indicated within the parentheses, and the unit is [mN/m]). Among these, aliphatic hydrocarbons (hexane, heptane, etc.) have low surface tension and are excellent in working environmental performance. Also, among these, a hydrophilic organic solvent such as acetone, methyl ethyl ketone, or 1,2-dimethoxyethane is used and thereby, can also serve as the organic solvent in the washing step. Among these, a solvent whose boiling point at normal pressure is 100° C. or lower may be used from the viewpoint that drying in the drying step mentioned later is easy. The solvents described above may be used alone or by mixing two or more types.

The amount of the solvent used in the solvent replacement step can be set to an amount that can sufficiently replace the solvent in the wet gel after the washing. The amount can be set to, for example, an amount of 3 to 10 times the volume of the wet gel.

The temperature environment in the solvent replacement step can be set to a temperature equal to or lower than the boiling point of the solvent used in replacement. In the case of using, for example, heptane, the temperature may be the order of 30 to 60° C.

As mentioned above, when silica particles are contained in the gel, a solvent replacement step is not essential. The presumed mechanism is as follows. When silica particles are not contained, it is preferable to replace the solvent of the wet gel with a predetermined solvent for replacement (solvent of low surface tension) in order to suppress shrinkage in the drying step. On the other hand, when silica particles are contained, it is thought that the skeleton is supported by the silica particles functioning as a support for the three-dimensional network skeleton, and the gel shrinkage in the drying step is suppressed. Therefore, it is considered that the gel can be directly subjected to the drying step without replacing the solvent used for the washing. The simplification of the drying step from the washing and solvent replacement step is possible in this way, but performing the solvent replacement step is not excluded at all.

(Drying Step)

In the drying step, the wet gel (washed and solvent-replaced as needed) as described above is dried.

The drying approach is not particularly limited, and publicly known drying under normal pressure, supercritical drying or freeze drying can be used. Among these, drying under normal pressure or supercritical drying can be used from the viewpoint of easily manufacturing aerogel having a low density. Also, drying under normal pressure can be used from the viewpoint that production at a low cost is possible. In the present embodiment, the normal pressure means 0.1 MPa (atmospheric pressure).

The aerogel according to the present embodiment can be obtained, for example, by drying the washed and (if necessary) solvent-replaced wet gel under atmospheric pressure at a temperature lower than the critical point of the solvent used in drying. Considering that, particularly, drying at a high temperature may accelerate the evaporation rate of the solvent and result in large cracks in the gel, the drying temperature may be, for example, 20 to 150° C., and may be 60 to 120° C., though differing depending on the type of replaced solvent (the solvent used for washing when solvent replacement is not performed). In addition, the drying time can be set to 4 to 120 hours, though differing depending on the volume of the wet gel and the drying temperature. In the present embodiment, the acceleration of drying by applying pressure lower than the critical point within a range not inhibiting productivity is also encompassed by the drying under normal pressure.

In the aerogel forming step according to the present embodiment, pre-drying may be performed before the drying step from the viewpoint of suppressing the cracks of the aerogel due to rapid drying. The pre-drying temperature may be, for example, 60 to 180° C., and may be 90 to 150° C. The pre-drying time may be, for example, 1 to 30 minutes, though differing depending on the volume of the aerogel and the drying temperature.

The drying method in the drying step may be, for example, supercritical drying. The supercritical drying can be performed by a publicly known approach. Examples of the supercritical drying method include a method of removing a solvent at a temperature and a pressure equal to or higher than the critical point of the solvent contained in the wet gel. Alternatively, examples of the supercritical drying method include a method of dipping the wet gel in liquid carbon dioxide under conditions on the order of, for example, 20 to 25° C. and 5 to 20 MPa to replace the whole or a portion of the solvent contained in the wet gel with carbon dioxide having a lower critical point than that of the solvent, and then removing the carbon dioxide alone or a mixture of the carbon dioxide and the solvent.

The aerogel obtained by such drying under normal pressure or supercritical drying may be further subjected to additional drying under normal pressure at 105 to 200° C. for approximately 0.5 to 2 hours. By this, aerogel having a low density and having small pores is more easily obtained. The additional drying may be performed under normal pressure at 150 to 200° C.

B: Coating Step

The coating step can comprise, for example, a liquid preparation step for preparing a coating liquid containing a coating material and a solvent, an infiltration step of infiltrating the obtained coating liquid into the aerogel and a solvent removal step of removing the solvent from the infiltrated coating liquid.

(Liquid Preparation Step)

The coating liquid is prepared by adding the coating material to the solvent. As the solvent, an organic solvent can be used from the viewpoint of permeability to the aerogel. As the organic solvent, an organic solvent having a small vapor pressure can be used from the viewpoint of easily removing the solvent at a low temperature in a later step, and an organic solvent having a boiling point of 100° C. or less can be used particularly. As the organic solvent, specifically, methanol, ethanol, isopropyl alcohol, 1,4-dioxane, dichloromethane, benzene, cyclohexane, methyl acetate, ethyl acetate, acetone, methyl ethyl ketone and the like can be used.

From the viewpoint of forming a coating of an appropriate thickness, the content (solid content) of the coating material in the coating liquid can be set to 1 mass % or more, but it may be 5 mass % or more, and it can be set to 40 mass % or less, but it may be 20 mass % or less. That is, the content of the coating material can be set to 1 to 40 mass %, but it may be 5 to 20 mass %.

The viscosity of the coating liquid can be set to 35 mPa·s or less at 25° C. from the viewpoint of sufficiently ensuring the permeability to the aerogel. From a similar viewpoint, the viscosity may be 20 mPa·s or less, and may be 10 mPa·s or less. The lower limit of the viscosity is not particularly limited, but can be set to 1 mPa·s, from the viewpoint of the likelihood of the process of the infiltration step. The viscosity can be measured by an E-type viscometer, a vibrating viscometer and the like.

(Infiltration Step)

In this step, the prepared coating liquid is infiltrated so as to sufficiently spread into the voids inside the aerogel. Specific examples include a dipping method in which the aerogel is infiltrated in the coating liquid and a coating method in which the coating liquid is coated on the aerogel. The infiltration method is not limited, and any suitable method may be used according to the size, shape, etc. of the aerogel. In the present embodiment, a coating liquid appropriately diluted is used so that the coating liquid infiltrates to the deep part of the aerogel (for example, the side in contact with the object to be heat-insulated). This step is not particularly based on the idea of providing a resin layer or the like on the surface of the aerogel, but on the idea of infiltrating the coating material to the inside of the aerogel to strengthen the skeleton itself of the aerogel. Since this allows improvement of the brittleness of the aerogel in addition to the dust fall, a heat-insulated object excellent in heat insulation reliability can be obtained.

In the case of the dipping method, the time during which the coating liquid is allowed to infiltrate is difficult to determine as a general rule, since it depends on the viscosity of the coating liquid, the wettability of the aerogel, etc., but it can be set to at least 5 seconds or more, it may be 10 seconds or more and may be 30 seconds or more. It is not particularly a problem if the time for infiltration is long, but it can be set to about 1 minute from the viewpoint of work efficiency.

In the case of the coating method, a die coater, a comma coater, a bar coater, a kiss coater, a roll coater or the like can be used as a coating method (coating machine). The coating amount can be set to 90 to 120% of the volume of the aerogel, from the viewpoint of sufficiently filling the voids of the aerogel with the coating liquid. If the coating amount is 90% or more, it is easy to suppress processing spots on the aerogel, and if it is 120% or less, excess resin hardly remains on the aerogel composite after solvent removal.

The temperature in the infiltration step can be appropriately adjusted so that the coating liquid can easily infiltrate the aerogel, depending on the type of coating material, the content of the coating material in the coating liquid, and the like. For example, by adjusting the temperature so that the viscosity of the coating liquid when infiltrating the coating liquid in the aerogel is 35 mPa·s or less, the infiltration step can be more suitably performed. From the viewpoint of achieving both work efficiency and good permeability, the temperature can be, for example, set to 0 to 80° C., may be 10 to 60° C. and may be 20 to 40° C.

(Solvent Removal Step)

In this step, the solvent in the coating liquid is removed from the aerogel in which the coating liquid has infiltrated. Thereby, the surface of the skeleton formed by the aerogel particles is coated with the coating material while maintaining a porous structure in the aerogel.

Since the removal of the solvent depends on the thickness of the aerogel, the type of the coating material, etc., it cannot be said as a general rule, but it can be performed at a heating temperature of 50 to 150° C. from the viewpoint of easily controlling the evaporation rate of the solvent. From the same viewpoint, the heating temperature may be 60 to 120° C. The heating time varies depending on the heating temperature, but can be set to 1 to 18 hours and may be 1 to 5 hours, from the viewpoint of sufficiently heating to the inside of the aerogel having heat transfer suppressing properties while ensuring work efficiency.

From the viewpoint of suppressing the destruction of the aerogel due to the foaming, etc. associated with the volatilization of the solvent, the heating treatment may be performed in multiple stages. For example, a first-stage heating (low-temperature heating) mainly removing the solvent and a second-stage heating (high-temperature heating) mainly curing the resin may be performed. The heating temperature and the heating time may be appropriately set within the above range.

C: Barrier Layer Forming Step

In the barrier layer forming step, a barrier layer is formed on the aerogel composite, for example, by bringing into contact a composition for forming a barrier layer containing a barrier layer-forming material with the aerogel composite, and then heating and drying as necessary. When other layers are provided on the aerogel composite, the composition for forming a barrier layer may be in contact with the other layers. Unlike the above-mentioned coating step, the purpose of this step is not to infiltrate the composition for forming a barrier layer into the aerogel composite. Therefore, in contrast to the above coating liquid, for example, the content (solid content) of the barrier layer-forming material in the composition for forming a barrier layer can be set at least to 40 mass %, and the viscosity of the composition for forming a barrier layer can be set to at least 35 mPa·s or more at 25° C. When employing a contact method (for example, spray coating described later) in which the composition for forming a barrier layer does not infiltrate into the aerogel composite, the content of the barrier layer-forming material may be set to about 40 mass %, or the viscosity of the composition for forming a barrier layer may be set to about 10 mPa·s.

The contact method can be appropriately selected depending on the type of the composition for forming a barrier layer, the thickness of the barrier layer, or the water repellency of the aerogel composite. Examples of the contact method include dip coating, spray coating, spin coating and roll coating. Among those, spray coating can be suitably used, from the viewpoint that the infiltration of the composition for forming a barrier layer to the inside of the aerogel is easily suppressed.

In the barrier layer forming step, from the viewpoint of drying and fixing the composition for forming a barrier layer, heat treatment may be performed, and from the viewpoint of removing impurities, washing or drying may be performed.

The heat-insulated object of the present embodiment described as above comprises an aerogel composite, which is aerogel with a skeleton reinforced with a coating material on the object to be heat-insulated. Therefore, while having the excellent low thermal conductivity of the aerogel itself, it has a toughness such that it can exhibit the low thermal conductivity over a long time. From such an advantage, the aerogel composite of the present embodiment can be applied to the use as a heat insulating material under various environments such as cryogenic containers, space field, construction field, automobile field, home appliance field, semiconductor field, industrial equipment, etc.

### EXAMPLES

The present invention will be hereinafter described in further detail with reference to Examples described below, but these Examples do not limit the present invention.

### (Preparation of Base Materials)

The following were prepared as base material.

For the evaluation of aerogel composite toughness: aluminum alloy plate: A6061P (manufactured by Takeuchi Metal Foil & Powder Industry Co., Ltd., product name, size: 300 mm×300 mm×0.5 mm, anodized)
For the measurement of the aerogel composite density: aluminum foil (thickness 20 μm)
For the measurement of the aerogel composite transmittance: slide glass (manufactured by Matsunami Glass Industry Co., Ltd., product name S1214: thickness 1.3 mm)

(Preparation of Sol Coating Solution)

200.0 parts by mass of water, 0.10 parts by mass of acetic acid as an acid catalyst, 20.0 parts by mass of CTAB as a cationic surfactant and 120.0 parts by mass of urea as a thermally hydrolyzable compound were mixed, and 40.0 parts by mass of a both terminally difunctional alkoxy-modified polysiloxane compound represented by the above formula (B) (hereinafter, referred to as “polysiloxane compound A”) as a polysiloxane compound and 60.0 parts by mass of MTMS as a silicon compound were added thereto and reacted at 25° C. for 2 hours. Thereafter, a sol-gel reaction was performed at 60° C. for 2 hours to obtain the sol coating solution.

The “polysiloxane compound A” was synthesized as follows: first, in a 1 L three-neck flask equipped with a stirrer, a thermometer and a Dimroth condenser, 100.0 parts by mass of dimethylpolysiloxane with silanol groups at both ends (manufactured by Momentive Performance Materials Inc., product name: XC96-723), 181.3 parts by mass of methyltrimethoxysilane and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally difunctional alkoxy-modified polysiloxane compound (polysiloxane compound A).

(Preparation of Coating Liquid)

40 g of silicone resin KR-300 (manufactured by Shin-Etsu Chemical Co., Ltd., resin content 50 mass %) and 4 g of amine-based curing agent KBM-603 (manufactured by Shin-Etsu Chemical Co., Ltd., resin content 100 mass %) were added to 76 g of diluted solvent MEK (2-butanone) and mixed to prepare a thermosetting resin coating liquid having a resin content of 20 mass % in the coating liquid. Moreover, the coating liquids having a resin content in the coating liquid of 5, 10, or 30 mass % were prepared by changing the quantity of each component. The viscosity of each coating liquid at 25° C. was measured using an E-type viscometer (manufactured by Toki Sangyo Co., Ltd., RE80H type, rotor 1° 34′×R24), with a sample volume of 1.1 mL, a temperature of 25° C., a rotational speed of 100 rpm and a measurement time of 1 minute. For the coating liquids having a resin content of 5 and 10 mass %, the viscosity was not measured since it was out of the measurement range (the viscosity was sufficiently low).

(Preparation of Composition for Forming Barrier Layer)

Fumed silica (manufactured by Aerosil Co., Ltd., Aerosil (registered trademark) R972) was mixed with AZ NL120A-20 containing perhydropolysilazane (manufactured by AZ Electronic Materials Manufacturing Co., Ltd., product name) to obtain a composition for forming a barrier layer. The content of fumed silica was set to 5 volume % with respect to the total volume of the barrier layer.

### Example 1

The aluminum alloy plate was dipped in the sol coating solution placed in a vat, then taken out and gelled at 60° C. for 30 minutes to obtain a structure having a gel layer thickness of 100 μm. Thereafter, the resulting structure was transferred to a closed vessel and aged at 60° C. for 12 hours.

The aged structure was immersed in 2000 mL of water and washed for 30 minutes. Next, it was immersed in 2000 mL of methanol and washed at 60° C. for 30 minutes. The washing by methanol was further performed twice while replacing with fresh methanol. Next, it was immersed in 2000 mL of methyl ethyl ketone and solvent replacement was performed at 60° C. for 30 minutes. The washing by methyl ethyl ketone was further performed twice while replacing with fresh methyl ethyl ketone. By drying the washed and solvent-replaced structure at 120° C. for 6 hours under normal pressure, aerogels having a structure represented by the above formulas (2) and (3) were formed on the aluminum alloy plate.

The aluminum alloy plate on which the aerogel was formed was taken out after being immersed in a coating liquid (resin content: 5 mass %) placed in a vat for 10 seconds. At this point, the excess adhering coating liquid was wiped off. The temperature of the coating liquid when infiltrating the coating liquid in the aerogel was 25° C. This was placed in a drier and heated at 90° C. for 1 hour, then at 150° C. for 1 hour to form an aerogel composite on the aluminum alloy plate and obtain an evaluation sample.

### Examples 2 to 4

Evaluation samples were obtained in the same manner as in Example 1, except that the coating liquid was changed as shown in Table 1.

### Example 5

In the same manner as in Example 3, the aerogel composite was formed on the aluminum alloy plate. Thereafter, the composition for forming a barrier layer was further coated on the aerogel composite using an air brush, and then heat curing was performed at 150° C. for 2 hours to form a barrier layer, which was used as an evaluation sample. The total thickness of the aerogel composite and the barrier layer was 120 μm.

### Comparative Example 1

In the same manner as in Example 1, the aerogel was formed on the aluminum alloy plate, and then evaluation sample was obtained without infiltrating the coating liquid.

### Comparative Example 2

In the same manner as in Comparative Example 1, the aerogel was formed on the aluminum alloy plate. Thereafter, in the same manner as in Example 5, a barrier layer was further formed on the aerogel to obtain an evaluation sample.

TABLE 1

| | | | Viscosity | |
|---|---|---|---|---|
| | | Resin Content | (mPa · s @ | Barrier |
| | Coating | (mass %) | 25° C.) | Layer |
| Example 1 | Thermosetting | 5 | — | — |
| Example 2 | resin coating | 10 | — | — |
| Example 3 | | 20 | 3.5 | — |
| Example 4 | | 30 | 10.2 | — |
| Example 5 | | 20 | 3.5 | Yes |
| Comparative | — | — | — | — |
| Example 1 | | | | |
| Comparative | — | — | — | Yes |
| Example 2 | | | | |

(Toughness Evaluation)

Each evaluation sample were stacked in 10 sheets, and a compressive force of 200 N was applied from the aerogel composite side using a metal jig (size 10 mm×1 mm×1 mm: 1 mm×1 mm surface is the sample contact surface) from above. Thereafter, it was visually confirmed whether the evaluation sample was crushed or cracked and evaluated according to the following criteria. The evaluation results are shown in Table 2.

Evaluation A: neither crushing nor cracking occurred in the evaluation sample.
Evaluation B: crushing occurred in the evaluation sample.
Evaluation C: crushing or cracking occurred in some of the evaluation samples.

(Density Measurement)

The density of the aerogel composite was measured. The aerogel composite or aerogel (50 μm in thickness) was formed on an aluminum foil according to the above procedure, and the density was measured using this as a measurement sample. The density was measured according to the geometric measurement method of JIS Z 8807. The volume was 5 cm×5 cm×50 μm (measured with a vernier caliper), and the weight was measured with an electronic balance to calculate the density of the measurement sample. The measurement results are shown in Table 2. In the table, Comparative Examples 1 and 2 show the density of the aerogel.

(Transmittance Measurement)

The transmittance of the aerogel composite to light with a wavelength of 500 to 700 nm was measured. The aerogel composite or aerogel (50 μm in thickness) was formed on a slide glass according to the above procedure, and the transmittance was measured using this as a measurement sample. The transmittance was measured according to JIS K 0115. The measurement results are shown in Table 2. The numerical values in the table are the results for the wavelengths 700 nm, 600 nm, and 500 nm from the left. Moreover, the transmittance (%) of slide glass and silicone resin was 88, 88, 88, respectively. In the table, Comparative Examples 1 and 2 show the transmittance of the aerogel.

TABLE 2

| | | Density of Aerogel | Transmittance of |
|---|---|---|---|
| | Toughness | Composite | Aerogel Composite |
| | Evaluation | (g/cm³) | (%) |
| Example 1 | A | 0.64 | <1, <1, <1 |
| Example 2 | A | 0.72 | <1, <1, <1 |
| Example 3 | A | 0.99 | <1, <1, <1 |
| Example 4 | A | 1.12 | 5, 4, 4 |
| Example 5 | A | 0.99 | <1, <1, <1 |
| Comparative | B | 0.40 | <1, <1, <1 |
| Example 1 | | | |
| Comparative | C | 0.40 | <1, <1, <1 |
| Example 2 | | | |

The aerogel composite of the Examples had excellent toughness.

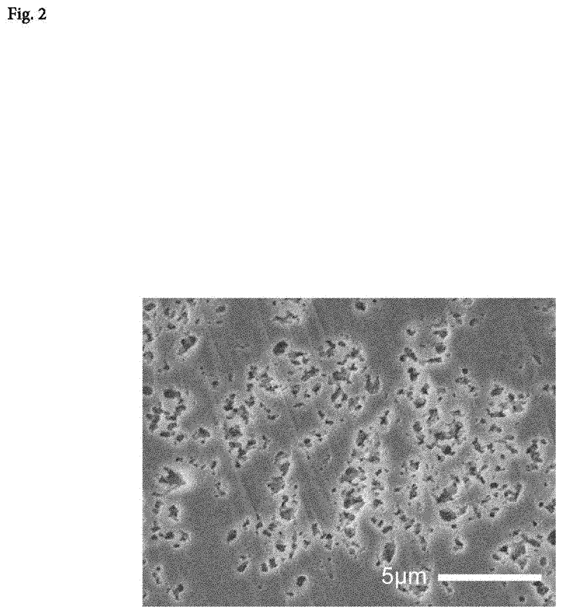

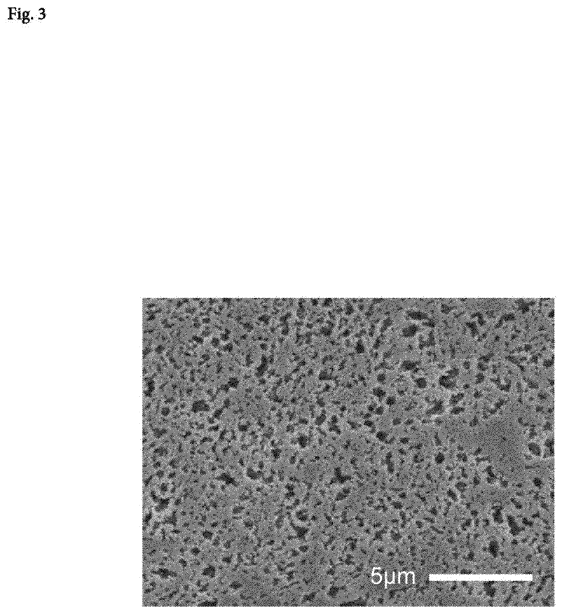

FIG. 2 is a cross-sectional SEM photograph of the aerogel composite obtained in Example 3, and FIG. 3 is a cross-sectional SEM photograph of the aerogel obtained in Comparative Example 1. In the former, it can be understood that the surface of the skeleton (the aerogel formed by the aerogel particles) is coated with the coating while maintaining the three-dimensional network skeleton of the aerogel. In view of such cross sections, and the measured densities and transmittances, the aerogel composites of the examples are expected to maintain good heat insulation properties.

### REFERENCE SIGNS LIST

1: Object to be heat-insulated, 2: Aerogel composite, 2a: Aerogel, 2b: Coating, 10: Heat-insulated object.

1. A process for producing an aerogel composite, comprising:
a step of infiltrating a coating liquid comprising a coating material and a solvent in aerogel; and
a step of removing the solvent from the infiltrated coating liquid.

2. The production process according to claim 1, wherein a viscosity at 25° C. of the coating liquid is 35 mPa·s or less.

3. The production process according to claim 1, wherein the coating material comprises a thermosetting resin.

4. The production process according to claim 1, wherein the aerogel is a dried product of wet gel being a condensate of sol containing at least one selected from the group consisting of a silicon compound having a hydrolyzable functional group or a condensable functional group, and a hydrolysis product of the silicon compound having a hydrolyzable functional group.

5. An aerogel composite comprising:
aerogel; and
a coating covering at least a portion of a surface of aerogel particles, the aerogel particles forming a void inside the aerogel.

6. The aerogel composite according to claim 5, wherein a density is 0.30 to 1.15 g/cm³.

7. The aerogel composite according to claim 5, wherein a transmittance to light with a wavelength of 700 nm is 15% or less.

8. A heat-insulated object comprising the aerogel composite according to claim 5 on an object to be heat-insulated.
